(19) United States
(12) Patent Application Publication
(10) Pub. No.: US 2016/0363650 A1
(43) Pub. Date: Dec. 15, 2016

(54) RADAR DETECTOR FREQUENCY DISTURBANCE SENSOR FILTERING SYSTEM AND METHOD

(71) Applicant: The Whistler Group, Inc., Bentonville, AR (US)

(72) Inventor: Michael Batten, Littleton, MA (US)

(73) Assignee: The Whistler Group, Inc., Bentonville, AR (US)

(21) Appl. No.: 15/176,054

(22) Filed: Jun. 7, 2016

Related U.S. Application Data
(60) Provisional application No. 62/174,301, filed on Jun. 11, 2015.

(51) Int. Cl. G01S 7/02

(52) U.S. Cl. CPC G01S 7/022

(57) ABSTRACT

A method to determine the presence of frequency-modulated continuous wave (FMCW) radar with user-selectable rejection of radar signals or modification of alert modes based on detection of radar signals of minimal interest.

This application claims priority to U.S. Provisional Patent Application No. 62/174,301 filed Jun. 11, 2015 and incorporated in its entirety herein by reference.

### BACKGROUND

1. Technical Field

The present invention relates to a detector device, and more particularly, a method to determine the presence of Frequency Disturbance Sensors transmitting FMCW (frequency-modulated continuous wave) radar used in recent radar based anti-collision systems, automatic door openers, and road signs while maintaining selectivity and minimizing the response time toward CW (continuous-wave) signals produced by police speed radar systems.

2. Description of the Related Art

As is generally known in the art, speed detection systems may be used to determine the speed of moving objects, such as automobiles and other motorized vehicles. Speed detection systems currently known in the art typically utilize either radar or laser devices in their operation. A police speed detection system that utilizes CW (continuous-wave) radar may generally be referred to as a so-called radar gun. Police radar typically includes a CW microwave signal source that emits a signal having a CW frequency in the radio-frequency electromagnetic spectrum. The radio-frequency spectrum utilized in speed-detection radar devices is divided into a series of bands, with each band covering a range of frequencies within the radio-frequency spectrum. The frequencies of interest range from about 10.500 to 36.000 GHz., although all the frequencies within this range are not allocated for speed-detection radar devices. The bands allocated for this purpose include: X-band, which ranges from 10.500-10.550 GHz.; K-band, which ranges from 24.050-24.250 GHz.; and Ka band, which presently ranges 33.400-36.000 GHz.

Operators of moving vehicles oftentimes find it useful know when the speed of their vehicle is being monitored by law enforcement. Thus, electronic assemblies for detecting the presence of police speed detection systems have been developed and are now in common use. Typically, such assemblies include a detection means, a processing means and a displaying means. For example, an electronic assembly capable of detecting the presence of speed detection systems utilizing radar is generally known and will be referred to as a radar detector. A radar detector typically includes an antenna, which receives radiated radio-frequency electromagnetic waves and converts them into electrical signals. A horn antenna is typical of conventional radar detectors. The horn antenna derives its name from the characteristic flared appearance. The flared portion can be square, rectangular, or conical. The maximum response of such an antenna corresponds with the axis of the horn.

Radar detector devices known in the art typically include a housing containing the detection, processing and displaying means. The housing is comprised of a generally rectangular box with the detection means protruding out one end, the displaying means fixed on the other end, and the processing means disposed there between. The housing may also include an internal power source or a port for an external power supply. The housing of such devices is typically mounted on the dashboard of a motor vehicle, a windshield mount, a rear view mirror mount, or clipped to an overhead visor. When properly mounted, the longitudinal axis of the detector device is typically oriented parallel with the longitudinal orientation of the motor vehicle. The detection means of the device is typically oriented with the front and/or, in some instances, the rear of the vehicle. The radar detector industry from the very beginning has had to deal with the reception of unwanted fixed location radar sources in the form of X or K band radar based security alarms, radar based automatic door openers, radar based traffic lights, radar based Traffic Flow systems, and more. It was common for these systems to operate at the same CW frequencies used by police speed radar causing a “cry wolf” syndrome as the radar detector would often alert you to the presence of these non-police systems causing the consumer to not pay attention when the alert was given from a police radar system. Consumer complaints to these fixed location systems have led to the term “door opener falsing”. This has caused radar detector manufacturers to be creative with City and Quiet modes to reduce sensitivity or alter the audible alert. Some have utilized methods to include a GPS and database of fixed location coordinates for confirmation of a known radar based system that is not associated with a police speed radar system within a determined radius of the radar detector. This information can be used to alter or not alert to the system thereby preventing a false alert thus satisfying the needs of the consumer.

More recently, new forms of unwanted alerts have gained momentum in the form of radar based anti-collision, blind spot, and lane change assistant devices built into the automobile. Many of these systems share a common frequency band with police speed radar. Unlike police radar, however, many of these systems use a sweeping method known as FMCW (frequency-modulated continuous-wave). These FMCW transceivers sweep a range of frequencies within a radar band at a rate of approximately 3 Mhz/ms, although some systems may have a slower or faster sweep rate. Radar detectors can also detect these slow FMCW systems and result in an unwanted “alert”. What makes this alert more aggravating is these systems are in a moving vehicle, can happen anywhere, and previous methods of utilizing GPS and a database of fixed locations have no effect. As early adaptations of these radar based FMCW systems were used by Audi, this is commonly referred to as “Audi falsing” although these systems have become more widespread recently and appear in several models manufactured by BMW, GM, Hyundai, Kia and others.

Some radar detectors utilize a method to reject other PRD (personal radar detectors) known as a PRD filter to minimize false alerts caused from other radar detectors. Software techniques such as 2-sweep rule, 3-sweep rule and 4-sweep rule are used in order to assure the consumer of the presence of CW (continuous-wave) police radar prior to alerting the consumer. Some have even resorted to designing the unit specifically to detect the presence of other radar detectors and ignore signals that reside on previous or future scans until the PRD is no longer detected. These methods do a reasonable job in reducing the number of false occurrences when in the presence of other radar detectors but the time to respond to a valid police radar source can range from 300 ms to 600 ms due to the time required to rule out offending PRD.

For the average user, this time was not critical. If the radar detector took an additional 300 milliseconds to determine if it will alert the driver, the delay is not sufficient to place the driver in a position of being seen before he is notified of the radar event further down the road. With the recent introduction of these FMCW systems, the current methods of PRD falsing may need to be increased to a 5 sweep rule, 6 sweep rule, 7 sweep rule, or more and could delay the reporting of police radar by as much as 1 full second before ruling it a false and moving on to scan a different band.

The PRD filter methods do not warn the user that their radar receiver may be compromised as all of the analysis is performed internally without the user having any knowledge of it. As the radar detector is receiving information consistent with what it determines to possibly be another radar detector, the appearance to the user is the same as if no radar was present and could result in brief periods where the unit may not report the presence of an actual police radar system if it occurred during the same period as a PRD false event that the radar detector is ignoring.

In the presence of an FMCW system, for example, a unit may alert for miles if a user is following a vehicle containing such a system. An extension of the previous PRD filter methods would assist to reject these FMCW systems. However as long as the user is following an FMCW system, the user is not made aware that the radar detector's abilities have been compromised and may not report the presence of a real police radar system in a timely manner if at all.

It is desirable to have a method for defining the presence of FMCW, while reducing false alerts, without the time delay of extended prior art methods in order to confirm the presence of FMCW and/or to scan for a different band sooner. It is also be desirable to be made aware when a user is in the presence of an FMCW system, as a failure to so inform may place the user at risk of not alerting to a police radar system while in the presence of the FMCW system. An added benefit of confirming FMCW systems and treating the alert accordingly can result in less annoying false alerts as non-police radar systems such as road signs and automatic door openers transition from CW to FMCW systems.

### SUMMARY OF THE INVENTION

The present invention provides a method for detecting radar. The invention begins by sweeping a first local oscillator (LO). Once a band has been identified as containing a radar signal or a potential radar signal, the detector interrupts its normal operation and immediately checks the band in question for confirmation of FMCW radar, rather than waiting for the initial sweep to finish.

If the information was from an FMCW source, the decision can be made to alert, not alert, provide an alternative alert, or ignore the band and move on to sweep a new band. By contrast, if the initial information were from a CW radar source, the FMCW information will not be present when the detector interrupts its normal operation and immediately checks the frequency in question for FMCW radar and the unit can proceed to report the band information with a reasonably high confidence that it was not created from an FMCW radar system.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1A is a block diagram illustrating a combination radar/laser detector device in which the present invention may be implemented;

FIG. 1B is a block diagram illustrating a combination radar/laser detector device with a dual-microprocessor configuration in which the present invention may be implemented;

FIG. 2 is a diagram illustrating a “saw tooth” method for detecting police radar in accordance with the prior art;

FIG. 3 illustrates a method for detecting police radar, using a reverse pattern from that of the saw tooth method, in accordance with the prior art;

FIG. 4 illustrates a radar detection method using both continuous wave and swept approaches in accordance with the prior art;

FIG. 5 illustrates an alternate radar detection method comprising both continuous wave and swept approaches, using a reverse pattern to that in FIG. 4, in accordance with the prior art;

FIG. 6 illustrates an embodiment of a radar detection method to check the radar in question for the presence of FMCW by interrupting the sweep after the presence of a band is detected in which no FMCW device is detected;

FIG. 7 illustrates an embodiment of a radar detection method to check the radar in question for the presence of FMCW by interrupting the sweep after the presence of a band is detected in which no FMCW device is detected;

FIG. 8 illustrates an embodiment of a radar detection method to check the radar in question for the presence of FMCW by interrupting the sweep after the presence of a band is detected in which a FMCW device is detected;

FIG. 9 illustrates an alternate radar detection method to check the radar in question for the presence of FMCW by interrupting the sweep after the presence of a band is detected in which a FMCW device is detected; and

FIG. 10 depicts a flowchart of a method performed according to an embodiment of the present FMCW radar detection system.

### DETAILED DESCRIPTION OF THE EMBODIMENTS

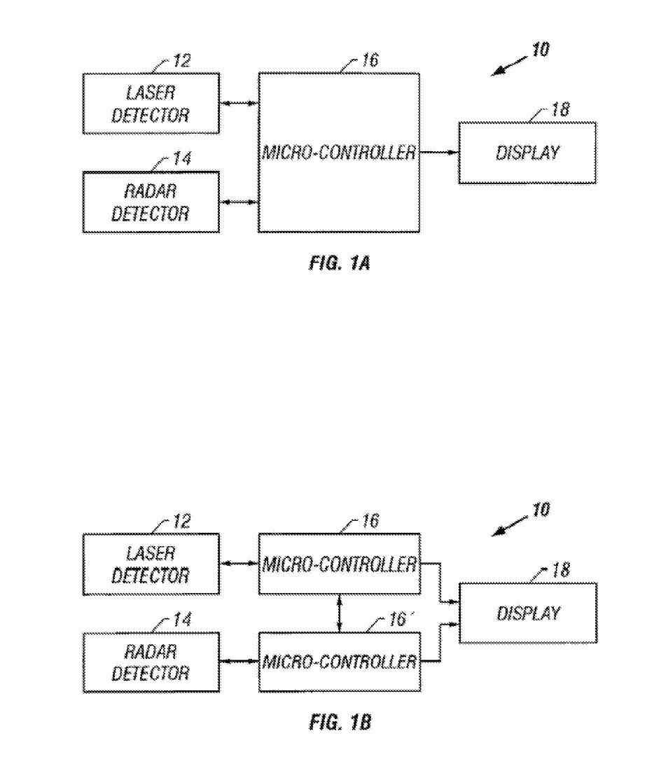

A block diagram of the electronic assembly of the preferred detector device is presented in FIGS. 1a and 1b. While there are many known electronic assemblies that would be adequate for this application, a device as described in U.S. Pat. No. 5,990,821, assigned to The Whistler Group, Inc. the disclosure of which is expressly incorporated herein by reference, will suffice. The detector device is a combination laser/radar detector 10 comprising a laser detector circuit 12 and a radar detector circuit 14. Laser detector circuit 12 and radar detector circuit 14 are each coupled to a microcontroller 16. Microcontroller 16 receives signals fed thereto from each of the laser and radar detector circuits 12, 14 and in response thereto microcontroller 16 provides control signals to the laser and radar detector circuits 12, 14 and to a display 18.

Displaying means may include, for example, a display screen comprised of light emitting diodes (LEDs). Alternatively or in addition thereto, displaying means may include a liquid crystal display (LCD) a vacuum fluorescent (VF) display, an LED segment display and the corresponding driver circuits, or an OLED segment display and the corresponding driver circuits. Those of ordinary skill in the art will recognize, of course, that other types of displays may also be used.

It should be noted that microcontroller 16 is here shown as a single microcontroller coupled to both the laser and radar detector circuits 12, 14. As shown in FIG. 1b, however, in an alternate embodiment of detector system 10, a pair of microcontrollers 16, 16′ may be provided with a first one of the pair being coupled to a first one of the laser and radar detector circuits 12, 14 and a second one of the pair of microcontrollers being connected to a second one of the laser and radar detector circuits 12, 14. The choice between using a single microcontroller or a pair of microcontrollers may be made according to a variety of factors including but not limited to the cost of manufacturing the detector system 10 having one microcontroller compared with the cost of manufacturing the detector system 10 having a plurality of separate microcontrollers.

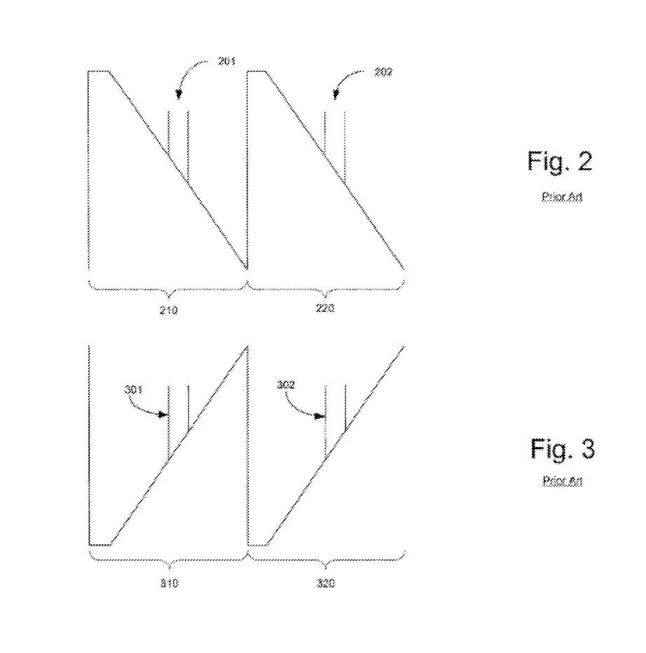

Referring now to FIG. 2, a diagram illustrating a “saw tooth” method for detecting police radar is depicted in accordance with the prior art. This method has been used on the majority of receivers for years and is very economical. Each “saw tooth” 210 and 220 represents a detector sweep over a particular range of radio frequencies. The paired information 201 and 202 on each sweep (210 and 220, respectively) is representative of alarm pulses necessary for band identification.

Upon detecting radar on a given sweep, manufacturers using this approach complete the sweep and then repeat the entire sweep a second, third, or fourth time to assure the presence of continuous wave (CW) radar versus information from an adjacent radar detector in a nearby car. This method does a reasonable job of filtering out false reports from other radar detectors of this type but requires significant time to repeat the sweep multiple times.

Using the example in FIG. 2, during the first sweep 210, the detector receives a paired alarm pulse 201, which might indicate the presence of CW (police) radar or another radar detector nearby. In order to confirm the likelihood of CW radar, the detector performs another sweep 220 and detects another paired pulse 202 at the same frequency (band). The detector may perform additional sweeps, but two is sufficient to illustrate the principle. Since a second paired pulse 202 is detected at the same band as the first pair pulse 201, it was assumed with a high degree of confidence that the signal is coming from a police CW radar system and not a nearby sweeping radar detector. The appearance of slow sweep rate FMCW systems may resemble a CW radar system for a period of at least two sweeps from the radar detector thus confirming what is believed to be CW radar. More repeat sweeps of the prior art are needed in order to differentiate the differences and to once again have a high degree of confidence in the decision that is made.

However, there is a considerable time penalty in performing these multiple sweeps, which is a disadvantage when attempting to confirm the presence of a slow sweeping FMCW radar system that are becoming common in vehicles containing anti-collision features.

FIG. 3 illustrates a method for detecting police radar using a reverse pattern from that of the saw tooth method in accordance with the prior art. This reverse sweep pattern has been used by a few manufacturers to minimize false alarms caused by radar detectors using the saw tooth direction sweep illustrated in FIG. 2. The principle is similar to that illustrated in FIG. 2. A first sweep 310 is performed, and if a paired alarm pulse 301 is detected, a second sweep 320 is performed. The presence of a paired alarm pulse 302 on the second sweep 320 indicates the presence of CW radar.

Because the crossing rates of the FIG. 3 sweep pattern opposes the pattern in FIG. 2, sensitivity toward detectors of no interest using the FIG. 2 saw tooth pattern is dramatically reduced. The sweep pattern illustrated in FIG. 3 does not offer a time or performance advantage over that of FIG. 2 with regard to police radar. Its primary benefit is a reduction of false alarms caused by more conventional saw tooth detectors. The manufacturer may or may not require additional sweeps to confirm CW versus other radar detectors, depending on the frequency plan and sensitivity to other detector models available on the market.

FIGS. 2 and 3 suffer from FMCW generated false alarms equally as field disturbance sensors sweep in both directions therefore they each have similar opportunity at crossing rates that oppose the sweep direction of the radar detector thus both have similar opportunity to detect the FMCW system at crossing rates that do not oppose the sweep direction of the radar detector.

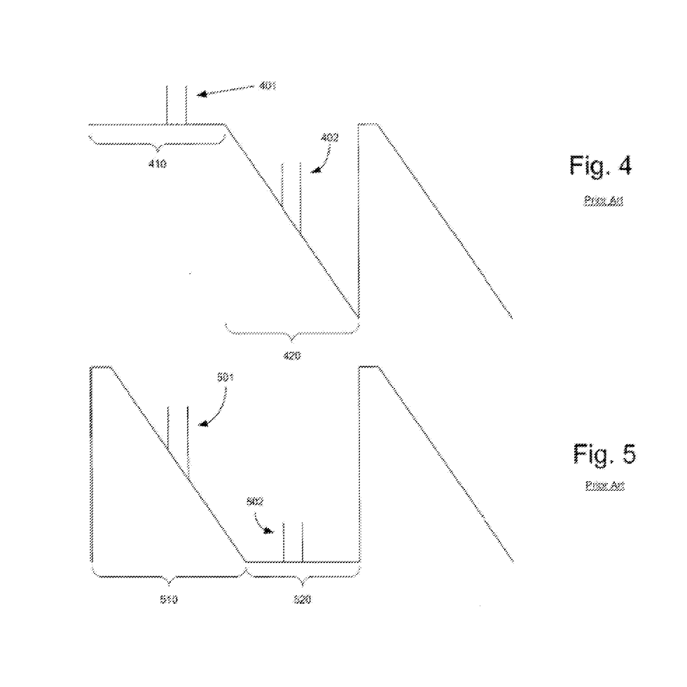

FIG. 4 illustrates a radar detection method using both CW and sweep approaches in accordance with the prior art. The method depicted in FIG. 4 begins in the CW mode 410, in which it is looking for sweeping emissions from other detectors. If sweeping radar is detected (indicated by alarm pair 401) during the CW operation, the detector may choose to ignore alarm pair signals 402 subsequently detected during its own sweep operation 420, in order to reduce false positives from other detectors. However, if no radar information is present during the CW operation 410, the detector may respond to radar alarm pair signals 402 subsequently detected during the sweep operation 420 due to the higher confidence that it came from police radar and not another detector.

An alternate method depicted in FIG. 5 follows the same general principle as that of FIG. 4. In this alternate method, the detector begins with a sweep operation 510, and if a radar alarm pair signal 501 is detected, the detector switches to a CW operation 520 to determine if the signal is from another sweeping detector. If an alarm pair signal 502 is detected during the CW mode 520, the detector may ignore it on subsequent sweeps.

The major disadvantage of the mixed methods depicted in FIGS. 4 and 5 is extra time spent searching for other radar detectors rather than police radar. At the same time, the user is interested in eliminating false positives while maintaining the necessary sensitivity towards actual police radar.

The methods and systems described herein advantageously provide a more efficient system for detecting the presence of FMCW radar in the first instance by dramatically reducing the amount of time the detector spends searching and confirming the source of a detected signal. The disclosed system also gathers data relating to the sensed FMCW radar source that enables further filtering to eliminate unwanted alerts and/or accept specific FMCW systems.

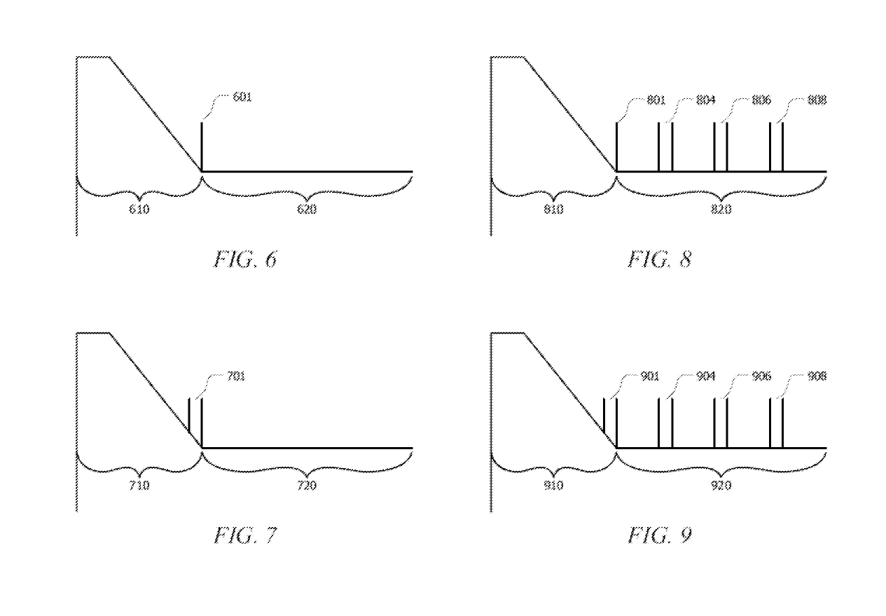

FIGS. 6 and 7 illustrate a detection process using interrupted sweeps to confirm the presence of FMCW radar shortly after first receiving a Band Identification. The process begins by sweeping a first local oscillator (LO). Once a band has been identified as containing a radar signal, the detector interrupts its normal operation and checks the band in question for confirmation of FMCW radar, rather than waiting for the initial sweep to finish. This approach allows for high-percentage validation of likely FMCW radar sources, while avoiding the time penalty associated with methods that perform multiple sweeps. As shown in FIG. 6, during CW detection mode 610 virtually immediately upon detection of a signal containing a radar signal 601, the system interrupts this mode of operation and FMCW confirmation mode ensues. In FIG. 6, once the system engages in FMCW confirmation mode 620, no FMCW radar source is detected. As such, it is likely that the signal may be sourced to a CW radar device. Note that during the FMCW detection mode of operation, the interruption of CW mode means that detection of a second signal in CW mode that is potentially sourced to another police radar device or the same radar device is temporarily delayed. Thus, once it is confirmed during FMCW confirmation mode 620 that no FMCW device is detected, CW operation resumes.

FIGS. 8 and 9 illustrate how the FMCW may be confirmed after the band has been identified during the period the radar detector has stopped sweeping. Because the radar detector has stopped sweeping it is able to gather data from an FMCW radar source that had caused the initial band ID (801, 901). The FMCW will result in data during this period (820, 920) that can be collected for the purposed of analyzing for specific rates if there were FMCW systems used by police speed radar that require an alert be given customary with that of CW police speed radar systems, likewise the data can be determined to be from a non-police radar source and treated accordingly. If no police speed radar employs FMCW, the result of any data during the FMCW check could result in the confirmation of an FMCW system.

FIG. 7 depicts another embodiment of the FMCW detection process. In FIG. 7, during CW detection mode 710 an alarm pair 701 is detected. In this embodiment of the mode of operation of the present detection system, CW sweeping is interrupted and FMCW detection mode is invoked upon detection of the complete alarm pair 701. That is, unlike CW sweeping depicted in FIGS. 6 and 8 that is discontinued upon detection of an alarm signal without awaiting detection of the complete pair, in the embodiment of FIG. 7, the CW sweep is discontinued but after the entire alarm pair 701 is detected. In this manner, the benefit of a rapid transition into and ultimately out of FMCW detection mode 720 is realized by ignoring the remainder of the entire CW sweep. As shown in the example of FIG. 7, once in FMCW detection mode 720 no FMCW generating device is detected, meaning that the alarm pair 701 may be sourced to a police radar. On the other hand, in FIG. 9 once the full alarm pair 901 is detected during CW detection mode 910, CW sweeping is halted and FMCW detection mode 920 is invoked. In this example, in FMCW detection mode various alarm pairs 904, 906 and 908 are detected, indicating that the alarm may be sourced to a FMCW device, such as those described above that generate a so-called “Audi falsing”.

FIG. 8 depicts a detection and confirmation method similar to that depicted in FIG. 6 to the extent that CW detection mode 810 is interrupted upon detection of a signal 801 containing a radar signal. In FIG. 8, however, once in FMCW confirmation mode 820 a FMCW source is actually detected as shown in detected alarm pairs 804, 806 and 808. Again, during FMCW detection mode of operation 820 the device will not detect the presence of a CW radar device and CW detection is temporarily halted. Of course, with the detection of an FMCW device as shown in FIG. 8, it is highly probable that the radar was sourced to a non-police radar.

Nevertheless, the user of the described radar detector must be made aware of two issues. First, as discussed, during FMCW detection mode the system's ability to detect other police-radar sources is interrupted. As such, the user ideally will be made aware when FMCW detection and confirmation is taking place. Accordingly, the system may alert the user by an audio or visual indicator (or both) that it is in FMCW detection and confirmation mode. In one embodiment of the present radar detector system, a variety of indicators may be made available to the user to identify that a radar source has been detected, followed by an indication that a FMCW source has been detected. The user may then respond accordingly based on this information.

Further, the system may permit the user to filter select FMCW sources according to settings available to the user. By example, the processing capability of residing in the microcontrollers depicted in FIGS. 1A and 1B may enable assignment of a value to FMCW alarms detected during FMCW detection mode. This value may be derived by calculating an average rate of pulses detected over a period of time. In the alternative, a value may be assigned to a FMCW signal associated with a particular source. Accordingly, the system may enable a user to set a threshold value beneath which the user will receive only a visual alarm of the presence of a FMCW radar source. Once the average rate or value exceeds or, in the alternative falls below, the threshold set by the user, a visual and audio alarm may be provided. Thus, the system provides the user with alerts that a FMCW device is detected, and with the added ability to control the intrusiveness of the alert according to the user's experience of whether the detected FMCW device is a device of concern.

The second area of concern for the user is that the FMCW radar source may be a police operated radar device. The value calculation process described above accounts for this concern as the disclosed system is a dynamic system that allows the user to modify user implemented filtering to provide alerting for particular calculated values associated with FMCW signals. Of course, if no FMCW device is detected in FMCW detection mode (620, 720, 820 and 920 in FIGS. 6-9), the radar detector will resume sweeping for a CW device in CW detection mode and if an alarm pair is swept again at the same frequency, indicating a high probability of the presence of police radar, the user will be alerted appropriately.

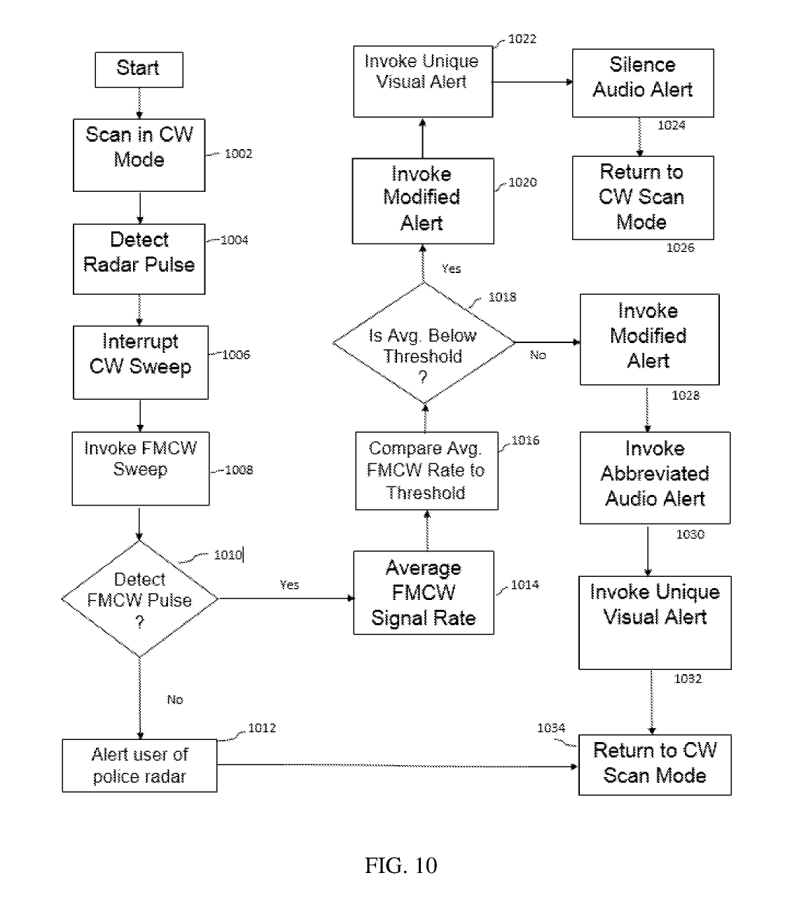

A method performed by an embodiment of the present FMCW filtering system of a continuous wave radar detector is described with reference to FIG. 10. In FIG. 10, the method begins at step 1002 with the radar detector operating in its primary mode to scan for continuous wave police radar at a frequency band between a first and second frequency. At step 1004, during a sweep a radar pulse is detected. The pulse may have a single or two-pulse signature. Once the radar pulse is detected, continuous wave sweeping is interrupted at step 1006 and at step 1008 FMCW sweep mode is invoked. In FMCW sweep mode, continuous wave radar signals are not detected but FMCW signals, of the type often emitted from non-police radar systems (such as collision avoidance systems), are detected. At step 1010, the system queries whether a FMCW pulse is detected. If the answer is no, then at step 1012, the user is alerted that the signal first detected was a continuous wave radar signal likely emitted from police radar. In other words, if no signal is detected in FMCW sweeping mode, the first signal detected in CW sweeping mode was very likely a continuous wave signal. The alert may be of the typical type with audio, visual effects or a combination to get the user's attention as to the source of the signal. The method then proceeds to step 1034 where the radar detector returns to sweeping in continuous wave mode.

If, on the other hand, at step 1010, a FMCW signal is detected during FMCW sweep mode, then a FMCW emitting device (likely non-police radar) is the source of the signal and the method continues at step 1014 with the collection of data to calculate the average rate of the FMCW signal. Based on this average rate, the signal may be of various levels of interest to the user. Accordingly, the average rate may be compared to a pre-established threshold level at step 1016. A threshold level may be set by the manufacturer to provide different levels of alerts to the user based on whether the average rate of the FMCW signal exceeds or falls beneath the threshold level. The threshold level may represent a value above which the emitting device may pose a moderate threat of being police radar. Accordingly, at step 1018 the device queries whether the average signal rate falls below the threshold level. If the answer is yes, then the process continues at step 1020 where a modified alert mode may be invoked. In modified alert mode, a unique visual alert at step 1022 may be provided to the user via the radar detector's user interface. This unique alert may take the form of a unique icon indicating the presence of a FMCW emitting source with the icon differing from an indication of continuous wave signal detection that has a high probability of being police radar. Alternatively, the unique visual alert may be of varying number of LEDs activated in a pattern or sequence distinct and perhaps less conspicuous than a police radar indication. At step 1024, the controller of the detector may silence the audio alert that would otherwise be provided to the user upon detection of a radar signal of concern. In this modified alert mode, the user is not disturbed by constant sources of radar, such as vehicle collision avoidance systems, that may otherwise trigger full audio and visual alerts to the user unnecessarily for many miles of travel. The method then concludes at step 1026 where the system returns to primary operation in continuous wave scanning mode.

If, on the other hand, at step 1018 the average rate of the FMCW signal is not below the threshold level, the signal may be of greater concern. Accordingly, the system proceeds to step 1028 where another mode of modified alerting is invoked. At step 1030 an abbreviated audio alert is provided to the user. This abbreviated audio alert is sufficient to alert the user of some level of a threat but the alert is not the full-blown audio alert indicative of the presence of a continuous wave signal that is almost certainly police radar. At step 1032, a unique visual alert is provided to the user, which may be similar to the unique visual alerts described above at step 1022 or a further modified alert that distinguishes this level of threat to the user. The method concludes at step 1034 and the radar detector returns to primary continuous wave scanning mode.

Although the invention hereof has been described by way of a preferred embodiment, it will be evident that other adaptations and modifications can be employed without departing from the spirit and scope thereof. The terms and expressions employed herein have been used as terms of description and not of limitation; and thus, there is no intent of excluding equivalents, but on the contrary it is intended to cover any and all equivalents that may be employed without departing from the spirit and scope of the invention.

### Additional Disclosure

The following clauses are offered as further description of the disclosed invention.

Clause 1. A method for confirming the presence of frequency-modulated continuous wave radar signal during continuous wave police radar detection operation, comprising the steps of:

scanning a frequency band between a first frequency and a second frequency;

detecting a first radar signal;

interrupting the continuous wave police radar detection operation; and

confirming that the detected radar signal is not a frequency-modulated continuous wave radar signal.

Clause 2. The method of any preceding or proceeding clause, wherein the interrupted continuous wave police radar detection operation is a sweep occurring in a vicinity of the detected radar signal to determine an average rate of the frequency-modulated continuous wave radar signal.
Clause 3. The method of any preceding or proceeding clause, wherein the average rate of the frequency-modulated continuous wave signal is determined by pulses detected during an interruption period.
Clause 4. The method of any preceding or proceeding clause, wherein the first detected radar signal comprises a two-pulse signal signature.
Clause 5. The method of any preceding or proceeding clause, wherein the first identified radar signal comprises a single-pulse signal signature.
Clause 6. The method of any preceding or proceeding clause, further comprising:

alerting a user that a continuous wave radar signal has been detected; and

resuming continuous wave radar detection operation.

Clause 7. The method of any preceding or proceeding clause, wherein the confirmation that the detected signal is not a frequency-modulated continuous wave radar signal occurs when no signal is detected during interruption of continuous wave radar detection operation.
Clause 8. The method of any preceding or proceeding clause, wherein the alerting comprises a visual indication of detection of a continuous wave radar signal.
Clause 9. The method of any preceding or proceeding clause, wherein the alerting comprises an audio indication of detection of a continuous wave radar signal.
Clause 10. A method of informing an operator of a vehicle of the presence of a frequency disturbance sensor device emitting a frequency-modulated continuous wave radar signal, the method comprising the steps of:

detecting a frequency-modulated continuous wave radar signal;

calculating an average rate of the radar signal;

comparing the average rate of the radar signal to a predetermined threshold rate; and

modifying a mode of alerting the operator of the presence of the radar signal according to the calculated average rate.

Clause 11. The method of any preceding or proceeding clause, wherein the radar signal is determined to be an unwanted signal if the average rate of the signal is less than a predetermined threshold value.
Clause 12. The method of any preceding or proceeding clause, wherein the radar signal is determined to be a signal of interest if the average rate of the signal is greater than a predetermined threshold value.
Clause 13. The method of any preceding or proceeding clause, wherein the radar signal is determined to be an unwanted signal if the average rate of the signal is greater than a predetermined threshold value.
Clause 14. The method of any preceding or proceeding clause, wherein the radar signal is determined to be a signal of interest if the average rate of the signal is less than a predetermined threshold value.
Clause 15. The method of any preceding or proceeding clause, wherein the modified mode of alerting the user comprises a silent mode.
Clause 16. The method of any preceding or proceeding clause, wherein the modified mode of altering the user comprises a unique abbreviated audio alert mode.
Clause 17. The method of any preceding or proceeding clause, wherein the modified mode of altering the user comprises a unique visual alert mode.
Clause 18. The method of any preceding or proceeding clause, wherein the visual alert mode includes presenting the operator with unique a textual indicator via a light emitting diode (LED) display.
Clause 19. The method of any preceding or proceeding clause, wherein the visual alert mode includes presenting the operator with a unique numerical indicator via a light emitting diode (LED) display.
Clause 20. The method of any preceding or proceeding clause, wherein the visual alert mode includes presenting the operator with a unique icon indicator.
Clause 21. A system for confirming the presence of a frequency disturbance sensor device emitting a frequency-modulated continuous-wave radar signal, comprising:

a housing;

an antenna; and

at least one controller configured to:

scan a frequency band between a first frequency and a second frequency according to a first mode of operation to detect a continuous wave radar signal;

interrupt the scan after a first radar signal is detected; and

determine according to a second mode of operation whether the first radar signal is a frequency-modulated continuous wave radar signal.

Clause 22. The system of any preceding or proceeding clause, wherein the interrupted scan occurs in a vicinity of the detected radar signal to determine an average rate of the frequency-modulated continuous wave radar signal.
Clause 23. The system of any preceding or proceeding clause, wherein the average rate of the frequency-modulated continuous wave signal is determined by pulses detected during the interruption of the scan.
Clause 24. The system of any preceding or proceeding clause, wherein the first detected radar signal comprises a two-pulse signal signature.
Clause 25. The system of any preceding or proceeding clause, wherein the first identified radar signal comprises a single-pulse signal signature.
Clause 26. The system of any preceding or proceeding clause, wherein the controller is further configured to:

alert a user that a continuous wave radar signal has been detected; and

resuming the first mode of operation following the determination of whether the first radar signal is a frequency-modulated continuous wave radar signal.

Clause 27. The system of any preceding or proceeding clause, wherein the determination that the detected signal is not a frequency-modulated continuous wave radar signal occurs when no signal is detected during interruption of the scan.
Clause 28. The system of any preceding or proceeding clause, wherein the determination that the detected signal is a frequency-modulated continuous wave radar signal occurs when a second radar signal is detected during interruption of the scan.
Clause 29. The system of any preceding or proceeding clause, wherein the alert comprises a visual indication of detection of a continuous wave radar signal.
Clause 30. The system of any preceding or proceeding clause, wherein the alert comprises an audio indication of detection of a continuous wave radar signal.
Clause 31. The system of any preceding or proceeding clause, wherein the controller is further configured to:

calculate an average rate of the frequency-modulated continuous wave radar signal;

compare the average rate of the frequency-modulated continuous wave radar signal to a predetermined threshold rate; and

modify a mode of alerting the user of the presence of the first radar signal according to the calculated average rate.

Clause 32. The system of any preceding or proceeding clause, wherein the first radar signal is determined to be an unwanted signal if the average rate of the signal is less than a predetermined threshold value.
Clause 33. The system of any preceding or proceeding clause, wherein the radar signal is determined to be a signal of interest if the average rate of the signal is greater than a predetermined threshold value.
Clause 34. The system of any preceding or proceeding clause, wherein the radar signal is determined to be an unwanted signal if the average rate of the signal is greater than a predetermined threshold value.
Clause 35. The system of any preceding or proceeding clause, wherein the radar signal is determined to be a signal of interest if the average rate of the signal is less than a predetermined threshold value.
Clause 36. The system of any preceding or proceeding clause, wherein the modified mode of alerting the user comprises a silent mode.
Clause 37. The system of any preceding or proceeding clause, wherein the modified mode of altering the user comprises a unique abbreviated audio alert mode.
Clause 38. The system of any preceding or proceeding clause, wherein the modified mode of altering the user comprises a unique visual alert mode.
Clause 39. The system of any preceding or proceeding clause, wherein the visual alert mode includes presenting the operator with unique a textual indicator via a light emitting diode (LED) display.
Clause 40. The system of any preceding or proceeding clause, wherein the visual alert mode includes presenting the operator with a unique numerical indicator via a light emitting diode (LED) display.
Clause 41. The system of any preceding or proceeding clause, wherein the visual alert mode includes presenting the operator with a unique icon indicator.

What is claimed is:

1. A method for confirming the presence of frequency-modulated continuous wave radar signal during continuous wave police radar detection operation, comprising the steps of:
scanning a frequency band between a first frequency and a second frequency;
detecting a first radar signal;
interrupting the continuous wave police radar detection operation; and
confirming that the detected radar signal is not a frequency-modulated continuous wave radar signal.

2. The method according to claim 1, wherein the interrupted continuous wave police radar detection operation is a sweep occurring in a vicinity of the detected radar signal to determine an average rate of the frequency-modulated continuous wave radar signal.

3. The method according to claim 2, wherein the average rate of the frequency-modulated continuous wave signal is determined by pulses detected during an interruption period.

4. The method according to claim 2, wherein the first detected radar signal comprises a two-pulse signal signature.

5. The method according to claim 2, wherein the first identified radar signal comprises a single-pulse signal signature.

6. The method of claim 1, further comprising:
alerting a user that a continuous wave radar signal has been detected; and
resuming continuous wave radar detection operation.

7. The method of claim 1, wherein the confirmation that the detected signal is not a frequency-modulated continuous wave radar signal occurs when no signal is detected during interruption of continuous wave radar detection operation.

8. The method of claim 6, wherein the alerting comprises a visual indication of detection of a continuous wave radar signal.

9. The method of claim 6, wherein the alerting comprises an audio indication of detection of a continuous wave radar signal.

10. A method of informing an operator of a vehicle of the presence of a frequency disturbance sensor device emitting a frequency-modulated continuous wave radar signal, the method comprising the steps of:
detecting a frequency-modulated continuous wave radar signal;
calculating an average rate of the radar signal;
comparing the average rate of the radar signal to a predetermined threshold rate; and
modifying a mode of alerting the operator of the presence of the radar signal according to the calculated average rate.

11. The method of claim 10, wherein the radar signal is determined to be an unwanted signal if the average rate of the signal is less than a predetermined threshold value.

12. The method of claim 10, wherein the radar signal is determined to be a signal of interest if the average rate of the signal is greater than a predetermined threshold value.

13. The method of claim 10, wherein the radar signal is determined to be an unwanted signal if the average rate of the signal is greater than a predetermined threshold value.

14. The method of claim 10, wherein the radar signal is determined to be a signal of interest if the average rate of the signal is less than a predetermined threshold value.

15. The method of claim 10, wherein the modified mode of alerting the user comprises a silent mode.

16. The method of claim 10, wherein the modified mode of altering the user comprises a unique abbreviated audio alert mode.

17. The method of claim 10, wherein the modified mode of altering the user comprises a unique visual alert mode.

18. The method of claim 17, wherein the visual alert mode includes presenting the operator with unique a textual indicator via a light emitting diode (LED) display.

19. The method of claim 17, wherein the visual alert mode includes presenting the operator with a unique numerical indicator via a light emitting diode (LED) display.

20. The method of claim 17, wherein the visual alert mode includes presenting the operator with a unique icon indicator.

21. A system for confirming the presence of a frequency disturbance sensor device emitting a frequency-modulated continuous-wave radar signal, comprising:
a housing;
an antenna; and
at least one controller configured to:
scan a frequency band between a first frequency and a second frequency according to a first mode of operation to detect a continuous wave radar signal;
interrupt the scan after a first radar signal is detected; and
determine according to a second mode of operation whether the first radar signal is a frequency-modulated continuous wave radar signal.

22. The system of claim 21, wherein the interrupted scan occurs in a vicinity of the detected radar signal to determine an average rate of the frequency-modulated continuous wave radar signal.

23. The system of claim 22, wherein the average rate of the frequency-modulated continuous wave signal is determined by pulses detected during the interruption of the scan.

24. The system of claim 21, wherein the first detected radar signal comprises a two-pulse signal signature.

25. The system of claim 21, wherein the first identified radar signal comprises a single-pulse signal signature.

26. The system of claim 21, wherein the controller is further configured to:
alert a user that a continuous wave radar signal has been detected; and
resuming the first mode of operation following the determination of whether the first radar signal is a frequency-modulated continuous wave radar signal.

27. The system of claim 21, wherein the determination that the detected signal is not a frequency-modulated continuous wave radar signal occurs when no signal is detected during interruption of the scan.

28. The system of claim 21, wherein the determination that the detected signal is a frequency-modulated continuous wave radar signal occurs when a second radar signal is detected during interruption of the scan.

29. The system of claim 26, wherein the alert comprises a visual indication of detection of a continuous wave radar signal.

30. The system of claim 26, wherein the alert comprises an audio indication of detection of a continuous wave radar signal.

31. The system of claim 26, wherein the controller is further configured to:
calculate an average rate of the frequency-modulated continuous wave radar signal;
compare the average rate of the frequency-modulated continuous wave radar signal to a predetermined threshold rate; and
modify a mode of alerting the user of the presence of the first radar signal according to the calculated average rate.

32. The system of claim 31, wherein the first radar signal is determined to be an unwanted signal if the average rate of the signal is less than a predetermined threshold value.

33. The system of claim 31, wherein the radar signal is determined to be a signal of interest if the average rate of the signal is greater than a predetermined threshold value.

34. The system of claim 31, wherein the radar signal is determined to be an unwanted signal if the average rate of the signal is greater than a predetermined threshold value.

35. The system of claim 31, wherein the radar signal is determined to be a signal of interest if the average rate of the signal is less than a predetermined threshold value.

36. The system of claim 31, wherein the modified mode of alerting the user comprises a silent mode.

37. The system of claim 31, wherein the modified mode of altering the user comprises a unique abbreviated audio alert mode.

38. The system of claim 31, wherein the modified mode of altering the user comprises a unique visual alert mode.

39. The system of claim 38, wherein the visual alert mode includes presenting the operator with unique a textual indicator via a light emitting diode (LED) display.

40. The system of claim 38, wherein the visual alert mode includes presenting the operator with a unique numerical indicator via a light emitting diode (LED) display.

41. The system of claim 38, wherein the visual alert mode includes presenting the operator with a unique icon indicator.
